(19) United States
(12) Patent Application Publication
(10) Pub. No.: US 2009/0003455 A1
(43) Pub. Date: Jan. 1, 2009

(54) METHOD AND APPARATUS FOR ILLUMINATION COMPENSATION IN MULTI-VIEW VIDEO CODING

(76) Inventors: Do-Young JOUNG, Seoul (KR); Tae-Sung Park, Yongin-si (KR); Yun-Je Oh, Yongin-si (KR); Doug-Young Suh, Seongnam-si (KR); Yung-Lyul Lee, Seoul (KR); Gwang-Hoon Park, Seongnam-si (KR); Kyu-Heon Kim, Seoul (KR); Min-Woo Park, Suwon-si (KR); Sung-Chang Lim, Seoul (KR)

Correspondence Address: CHA & REITER, LLC, 210 ROUTE 4 EAST STE 103, PARAMUS, NJ, 07652, US

(21) Appl. No.: 12/146,697

(22) Filed: Jun. 26, 2008

(30) Foreign Application Priority Data
Jun. 26, 2007 (KR) 62911/2007
Feb. 19, 2008 (KR) 15011/2008

(51) Int. Cl. H04N 7/12

(52) U.S. Cl. 375/240.24; 375/E07.076

(57) ABSTRACT

Disclosed is a method and apparatus for illumination compensation in a multi view video coding. The method includes deriving a predicted illumination compensation value of the current block by using information on neighbor blocks of the current block when a current block performing illumination compensation is in a skip mode; setting the current block not to perform the illumination compensation when the derived predicted illumination compensation value is 0 and setting the current block to perform the illumination compensation when the derived predicted illumination compensation value is not 0.

### CLAIM OF PRIORITY

This application claims the benefit of the earlier filing date, under 35 U.S.C. §119(a), to those patent applications entitled “Method And Apparatus For Illumination Compensation In Multi-View Video Coding” filed in the Korean Intellectual Property Office on Jun. 26, 2007 and Feb. 19, 2008, and assigned Serial Nos. 2007-62911 and 2008-15011, respectively, the contents of both of which are hereby incorporated by reference.

### RELATED APPLICATION

This application is related to patent application Ser. No. 12/145,578, entitled “Method and Apparatus for Illumination Compensation in Multi-View Video Coding,” filed on Jun. 25, 2008 in the United States Patent and Trademark office, the contents of which are incorporated by reference, herein.

### BACKGROUND OF THE INVENTION

1. Field of the Invention

The present invention relates to Multi-view Video Coding (MVC), and more particularly to a method and an apparatus for obtaining a predicted illumination compensation value and an illumination compensation flag value during the process of illumination compensation in multi-view video coding.

2. Description of the Related Art

With development in video technologies, analog picture processing methods are being replaced by digital picture processing methods. As a result, it has become possible to provide users with pictures which are clearer and have higher picture qualities than pictures captured with older technologies. The improvement in the picture quality has provided users with a much stronger feeling of presence. Recently, a High Definition (HD) Television (TV) service for broadcasting a high quality picture is being provided, and commercialization of a Digital Multimedia Broadcast (DMB) service transmitting vivid and clear pictures regardless of the place is being prepared. However, the high quality digital video service, which improves the quality of only the picture itself, has a limit in improving the degree of freedom and the feeling of presence that users have. Representative elements degrading the feeling of presence in the use of a picture include a camera having a fixed view and an picture lacking depth. The fixed camera view degrades the degree of freedom, since it does not allow a user to view a prospective other than that of a current picture while the user views the current picture. Further, since a person can see an object by their eyes being oriented in the same direction from different positions, he or she can feel the depth of the object by means of binocular disparity. However, the picture obtained by the fixed camera cannot give the feeling of depth, as it does not take binocular disparity into consideration. In order to solve this problem, a method of simultaneously obtaining multi-view pictures through multiple cameras at multiple viewpoints is being developed.

A scheme for coding multi-view pictures as described above is called a Multi-view Video Coding (MVC) scheme. The MVC refers to a scheme for processing sequences of multiple views of pictures obtained through multiple cameras. According to the MVC, multiple cameras are located at different distances from the same object and/or their orientations toward the same object. The multi-view pictures obtained through the multiple cameras show different degrees of reflections of light from the surface of the same object according to their directions, while the pictures of the views have are highly related. This characteristic of the multi-view pictures results in differences in the brightness and color of the pictures for the same object according to the particular view. Therefore, in order to improve the encoding efficiency in the multi-view video coding, the above-described characteristic of the multi-view pictures should be taken into consideration.

The multi-view video coding, standardization of which is actively in progress, is searching for a method for improving an encoding efficiency in consideration of the two above-described characteristics of the multi-view pictures based on the H.264/MPEG-4 part 10 Advanced Video Coding (H.264/AVC), which is an existing international standard for video coding. For example, a hierarchical B-picture coding, which is a method for supporting a temporal scalability in a Joint Scalable Video Coding (JSVC) defined in the H.264/AVC, is also applied to an intra-view prediction coding within the multi-view video coding. Further, in the multi-view video coding performs, an inter-view prediction coding is also performed in parallel, so as to improve the coding efficiency.

FIG. 1 illustrates an example of a prediction structure showing intra-view prediction and inter-view prediction relations in the multi-view video coding. In the example shown in FIG. 1, eight views exist and the Group Of Pictures (GOP) of the temporal direction has a size of 8. In FIG. 1, each of S0, S1, S2, S3, . . . S7 indicates one view, and T0, T1, T2, T3, . . . T100 indicate a temporal direction.

Referring to FIG. 1, it is noted that a prediction coding in the temporal direction is performed by using the hierarchical B-picture coding defined in the H.264/AVC in each view. Further, in each view, a picture of the first time band T0 and pictures (at T8, T16, T24, . . . ) spaced every 8 frames (which is the size of a GOP) away from the picture of the first time band T0 are called “anchor pictures.” For the anchor pictures, only the prediction (i.e. inter-view prediction) from neighbor views is performed. For example, at the time bands T0, T8, T16, T24, . . . , prediction is performed for the S2 view from the S0 view of the same time band, for the S1 view from the S0 view and the S2 view of the same time band, for the S4 view from the S2 view of the same time band, for the S3 view from the S2 view and the S4 view of the same time band, for the S6 view from the S4 view of the same time band, for the S5 view from the S4 view and the S6 view of the same time band, and for the S7 view from the S6 view of the same time band. In the case of the S7 view, since it is the last view, its prediction is performed from the S6 view, etc.

For non-anchor pictures, prediction of the temporal direction is basically performed, and prediction from neighbor views is additionally performed for every second view (i.e. S1, S3, S5, and S7). That is, not only intra-view prediction of the temporal direction is performed, but also inter-view prediction is performed for the S1 view from the S0 view and the S2 view, for the S3 view from the S2 view and the S4 view, and for the S5 view from the S4 view and the S6 view.

The multi-view video coding, international standardization of which is currently in progress, employs an illumination compensation method in order to improve a coding efficiency by compensating for a difference between luminance signals existing in the temporal direction or between views.

Illumination compensation-related data include flag information indicating if a current block uses illumination compensation, an illumination compensation value that includes an IC offset or a Difference Value of Illumination Change (DVIC; a luminance signal average difference between a current block and a reference block), and information regarding if illumination compensation will be performed and regarding a predicted illumination compensation value derived from neighbor blocks.

### SUMMARY OF THE INVENTION

Accordingly, the present invention provides a method and an apparatus for efficiently predicting a flag indicating whether to perform illumination compensation and a predicted illumination compensation value in multi-view video coding.

In accordance with an aspect of the present invention, there is provided a method of illumination compensation in a multi view video coding, the method including the steps of determining when a current block performing illumination compensation is in a skip mode, and deriving a predicted illumination compensation value of the current block by using information on neighbor blocks of the current block and when the derived predicted illumination compensation value is 0, setting the current block not to perform the illumination compensation; and when the derived predicted illumination compensation value is not 0, setting the current block to perform the illumination compensation.

When the current block is in a P skip mode, the neighbor blocks of the current block include a first block, which is an upper neighbor block of the current block, and a second block, which is a left neighbor block of the current block.

When the current block is in a P skip mode, the step of deriving a predicted illumination compensation value of the current block includes the steps of determining when both the first block, which is the upper neighbor block of the current block, and the second block, which is the left neighbor block of the current block, perform illumination compensation, setting an average of illumination compensation values of the first block and the second block as a predicted illumination compensation value of the current block and when the first block performs illumination compensation while the second block does not perform illumination compensation, setting an illumination compensation value of the first block as the predicted illumination compensation value of the current block and when the second block performs illumination compensation while the first block does not perform illumination compensation, setting an illumination compensation value of the second block as the predicted illumination compensation value of the current block; and when both of the first block and the second block do not perform illumination compensation, setting the predicted illumination compensation value of the current block to 0.

The step of setting the current block not to perform the illumination compensation corresponds to setting a flag value indicating if the current block performs illumination compensation to 0, and the step of setting the current block to perform the illumination compensation corresponds to setting the flag value indicating if the current block performs illumination compensation to 1.

In accordance with another aspect of the present invention, there is provided a method of illumination compensation in a multi view video coding, the method including the steps of determining when a current block is in a block mode transmitting an illumination compensation value difference and a flag indicating if the current block performs illumination compensation, calculating an illumination compensation value; when the illumination compensation value is 0, setting the current block not to perform the illumination compensation; and when the illumination compensation value is not 0, setting the current block to perform the illumination compensation.

The step of setting the current block not to perform the illumination compensation corresponds to setting a flag value indicating if the current block performs illumination compensation to 0, and the step of setting the current block to perform the illumination compensation corresponds to setting the flag value indicating if the current block performs illumination compensation to 1.

In accordance with another aspect of the present invention, there is provided a method of illumination compensation in a multi view video coding, the method including the steps of determining when a current block is in a block mode transmitting an illumination compensation value difference and a flag indicating if the current block uses illumination compensation, calculating an illumination compensation value and deriving a predicted illumination compensation value by using neighbor blocks of the current block and when the illumination compensation value and the predicted illumination compensation value are 0, setting the current block not to perform the illumination compensation and when any of the illumination compensation value and the predicted illumination compensation value is not 0, setting the current block to perform the illumination compensation.

When the current block is in a block mode transmitting an illumination compensation value difference and a flag indicating if the current block performs illumination compensation, the neighbor blocks of the current block include a first block, which is an upper neighbor block of the current block, a second block, which is a left neighbor block of the current block, a third block, which is a right neighbor block of the first block, and a fourth block, which is an upper neighbor block of the second block.

The step of deriving a predicted illumination compensation value of the current block includes the steps of determining if the first block, which is the upper neighbor block of the current block, uses illumination compensation and if a picture referred to by the first block is equal to a picture referred to by the current block, and setting an illumination compensation value of the first block as the predicted illumination compensation value of the current block when the picture referred to by the first block is equal to the picture referred to by the current block; when the picture referred to by the first block is not equal to the picture referred to by the current block, determining if the second block, which is the left neighbor block of the current block, uses illumination compensation and if a picture referred to by the second block is equal to the picture referred to by the current block, and setting an illumination compensation value of the second block as the predicted illumination compensation value of the current block when the picture referred to by the second block is equal to the picture referred to by the current block and when the picture referred to by the second block is not equal to the picture referred to by the current block, determining if the third block, which is the right neighbor block of the first block, uses illumination compensation and if a picture referred to by the third block is equal to the picture referred to by the current block, and setting an illumination compensation value of the third block as the predicted illumination compensation value of the current block when the picture referred to by the third block is equal to the picture referred to by the current block and when the picture referred to by the third block is not equal to the picture referred to by the current block, determining if the fourth block, which is the upper neighbor block of the second block, uses illumination compensation and if a picture referred to by the fourth block is equal to the picture referred to by the current block, and setting an illumination compensation value of the fourth block as the predicted illumination compensation value of the current block when the picture referred to by the fourth block is equal to the picture referred to by the current block and when the picture referred to by the fourth block is not equal to the picture referred to by the current block, determining if all of the first block, the second block, and the third block use illumination compensation, and setting a median value of illumination compensation values of the first block, the second block, and the third block as the predicted illumination compensation value of the current block when all of the first block, the second block, and the third block use illumination compensation; and when any of the first block, the second block, and the third block does not perform illumination compensation, setting the predicted illumination compensation value of the current block to 0.

The step of setting the current block not to perform the illumination compensation corresponds to setting a flag value indicating if the current block performs illumination compensation to 0, and the step of setting the current block to perform the illumination compensation corresponds to setting the flag value indicating if the current block performs illumination compensation to 1.

In accordance with another aspect of the present invention, there is provided an apparatus for illumination compensation when a current block performing illumination compensation is in a skip mode in a multi view video coding, the apparatus including a predicted illumination compensation value deriver for receiving a reference picture index of the current block and information on neighbor blocks of the current block, and deriving and outputting a predicted illumination compensation value, a flag setting unit for receiving the derived predicted illumination compensation value, and setting and outputting a flag indicating if the current block performs illumination compensation, based on the derived predicted illumination compensation value and an illumination compensation/movement compensation unit for performing illumination compensation and movement compensation by using a movement vector, a reference picture, the predicted illumination compensation value, and the flag indicating if the current block performs illumination compensation.

The flag setting unit sets a flag value indicating if the current block performs illumination compensation to 0 when the received derived predicted illumination compensation value is 0, and sets the flag value to 1 when the received derived predicted illumination compensation value is not 0.

In accordance with another aspect of the present invention, there is provided an apparatus of illumination compensation when a current block is in a block mode transmitting an illumination compensation value difference and an illumination compensation indicating flag indicating if the current block uses illumination compensation in a multi view video coding, the apparatus including: an illumination compensation value-based movement predictor for extracting a movement vector by using input pictures and reference pictures, and outputting an illumination compensation value and a reference picture index; a predicted illumination compensation value deriver for deriving and outputting a predicted illumination compensation value by using a reference picture index input from the illumination compensation value-based movement predictor and information of neighbor blocks of the current block; a flag setting/encoding unit for receiving the illumination compensation value from the illumination compensation value-based movement predictor and the predicted illumination compensation value from the predicted illumination compensation value deriver, and setting, encoding, and outputting the illumination compensation indicating flag; and an illumination compensation value information encoding unit, which does not encode information of the illumination compensation value when the flag is 0, and encodes and outputs an illumination compensation value difference, which is obtained by subtracting the predicted illumination compensation value input from the predicted illumination compensation value deriver from the illumination compensation value, when the flag is 1.

The flag setting/encoding unit sets the illumination compensation indicating flag to 0 when the received derived predicted illumination compensation value is 0, and sets the illumination compensation indicating flag to 1 when the received derived predicted illumination compensation value is not 0.

The flag setting/encoding unit sets the illumination compensation indicating flag to when the illumination compensation value and the predicted illumination compensation value are 0, and sets the illumination compensation indicating flag to 1 when any of the illumination compensation value and the predicted illumination compensation value is not 0.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates an example of a prediction structure showing conventional intra-view prediction and inter-view prediction relations in the multi-view video coding;

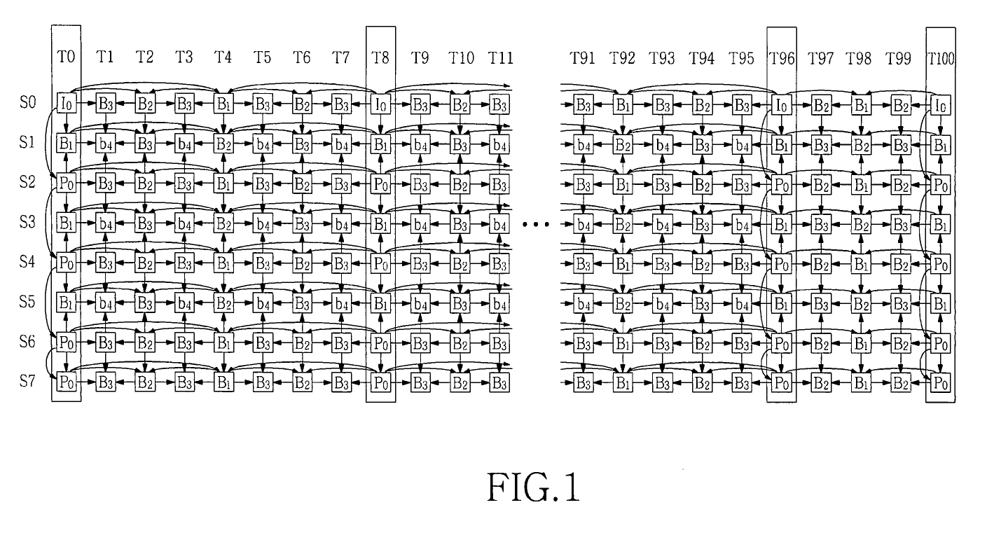

FIG. 2 illustrates neighbor blocks used in order to derive a predicted illumination compensation value in a multi-view video coding;

FIG. 3 is a flow diagram of a process of deriving a predicted illumination compensation value from neighbor blocks in the case of transmitting an illumination compensation indicating flag and an illumination compensation value difference;

FIG. 4 is a flow diagram of a process of deriving a predicted illumination compensation value and an illumination compensation indicating flag from P skip mode blocks;

FIG. 5 is a flow diagram of a process of deriving a predicted illumination compensation value and an illumination compensation indicating flag from P skip mode blocks;

FIG. 6 is a flow diagram of a process of deriving a predicted illumination compensation value and an illumination compensation indicating flag from P skip mode blocks according to another embodiment of the present invention;

FIG. 7 is a flow diagram of a process of predicting an illumination compensation indicating flag in the case of transmitting an illumination compensation indicating flag and an illumination compensation value difference according to an embodiment of the present invention;

FIG. 8 is a flow diagram of a process of predicting an illumination compensation indicating flag in the case of transmitting an illumination compensation indicating flag and an illumination compensation value difference according to another embodiment of the present invention;

FIG. 9 is a block diagram of an apparatus for deriving a predicted illumination compensation value and an illumination compensation indicating flag from skip mode blocks according to an embodiment of the present invention;

FIG. 10 is a flow diagram of an encoder for encoding an illumination compensation indicating flag and an illumination compensation value in a block mode in the case of transmitting an illumination compensation indicating flag and an illumination compensation value difference according to an embodiment of the present invention;

FIG. 11 is a graph showing a comparison between an existing illumination compensation method and an illumination compensation method according to an embodiment of the present invention for a Racel VGA 30 Hz picture sequence; and

FIG. 12 is a graph showing a comparison between an existing illumination compensation method and an illumination compensation method according to an embodiment of the present invention for a Ballroom VGA 25 Hz picture sequence.

### DETAILED DESCRIPTION OF THE INVENTION

Exemplary embodiments of the present invention will be described with reference to the accompanying drawings. In the following description, various specific definitions found in the following description are provided only to help general understanding of the present invention, and it is apparent to those skilled in the art that the present invention can be implemented without such definitions. For the purposes of clarity and simplicity, a detailed description of known functions and configurations incorporated herein will be omitted when it may make the subject matter of the present invention rather unclear.

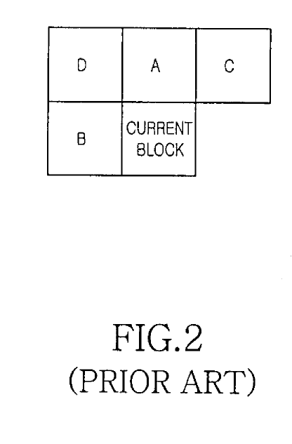

FIG. 2 illustrates neighbor blocks used in order to derive a predicted illumination compensation value in a multi-view video coding. In the case of determining whether to perform illumination compensation and deriving a predicted illumination compensation value from neighbor blocks, neighbor blocks A, B, C, and D around the current block as shown in FIG. 2 are used as the neighbor blocks. In the case of transmitting an illumination compensation value, a predicted illumination compensation value is derived from the neighbor blocks, and an illumination compensation value difference (i.e., the illumination compensation value minus the predicted illumination compensation value) is then transmitted.

Methods of deriving information on whether to perform illumination compensation and a predicted illumination compensation value are different according to the types of blocks, which include three block types. The first block type corresponds to a case of transmitting a flag indicating whether to perform illumination compensation and an illumination compensation value difference (inter 16×16 mode, B direct 16×16 mode), the second block type corresponds to a P skip mode, and the third block type corresponds to a B skip mode.

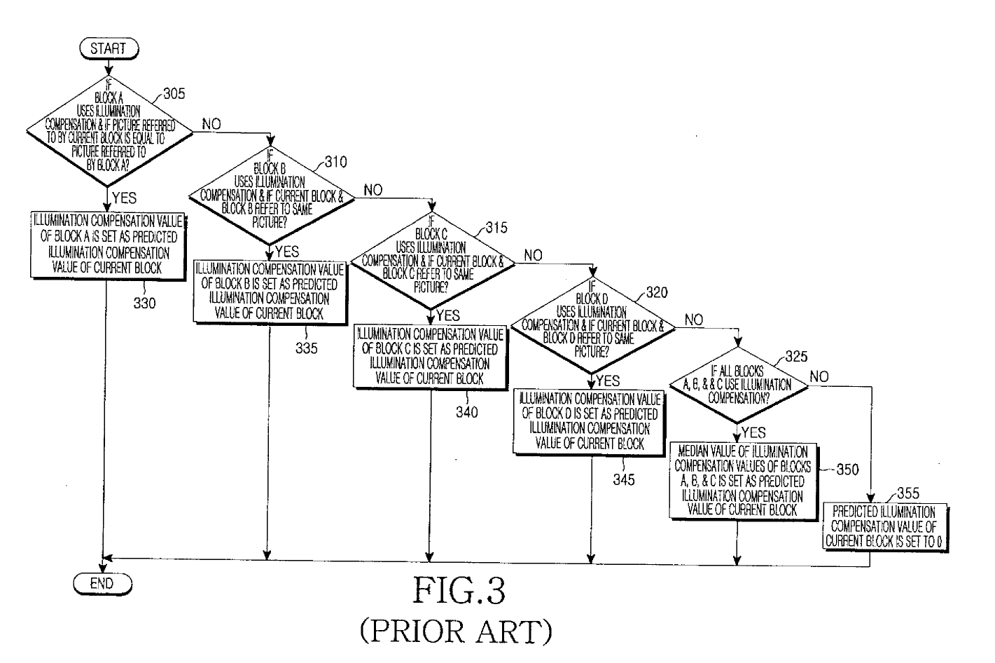

First, a method of deriving a predicted illumination compensation value from neighbor blocks (blocks A, B, C, and D of FIG. 2) adjacent to a current block in the case of transmitting a flag and an illumination compensation value difference (inter 116×16 mode, B direct 16×16 mode) will be described with reference to FIG. 3.

FIG. 3 is a flow diagram of a process of deriving a predicted illumination compensation value from neighbor blocks in the case of transmitting an illumination compensation indicating flag and an illumination compensation value difference.

Referring to FIG. 3, first in step 305, it is determined whether the block A, which is an upper neighbor block of the current block, uses illumination compensation, and if a picture referred to by the current block is equal to a picture to which the block A refers. As a result of the determination in step 305, when the block A uses illumination compensation and the current block and the block A refer to the same picture, the illumination compensation value of the block A is used as the predicted illumination compensation value of the current block (step 330). Then, the process is terminated.

As a result of the determination in step 305, when the answer is “No,” a determination is made whether the block B, which is a left neighbor block of the current block, uses illumination compensation, and if the current block and the block B refer to the same picture (step 310). As a result of the determination in step 310, when the block B uses illumination compensation and the current block and the block B refer to the same picture, the illumination compensation value of the block B is used as the predicted illumination compensation value of the current block (step 335). Then, the process is terminated.

As a result of the determination in step 310, when the answer is “No,” a determination is made whether the block C, which is a right neighbor block of the current block, uses illumination compensation, and if the current block and the block C refer to the same picture (step 315). As a result of the determination in step 315, when the block C uses illumination compensation and the current block and the block C refer to the same picture, the illumination compensation value of the block C is used as the predicted illumination compensation value of the current block (step 340). Then, the process is terminated.

As a result of the determination in step 315, when the answer is “No,” a determination is made whether the block D, which is an upper neighbor block of the block B, uses illumination compensation, and if the current block and the block D refer to the same picture (step 320). As a result of the determination in step 320, when the block D uses illumination compensation and the current block and the block D refer to the same picture, the illumination compensation value of the block D is used as the predicted illumination compensation value of the current block (step 345). Then, the process is terminated.

As a result of the determination in step 320, when the answer is “No,” a determination is made whether all of the blocks A, B, and C use illumination compensation (step 325). As a result of the determination in step 325, when all of the blocks A, B, and C use illumination compensation, a median value of the illumination compensation values of the blocks A, B, and C is set as the predicted illumination compensation value of the current block (step 350). Then, the process is terminated.

As a result of the determination in step 325, when the answer is “No,” the predicted illumination compensation value of the current block is set to “0” (step 355). Then, the process is terminated.

The median value set in step 350 corresponds to a value selected from among a set of numbers such that a half of the numbers of the set is larger than the median value and the other half thereof is smaller than the median value. If the set includes an even number of numbers, an average of two middle numbers is determined as the median value.

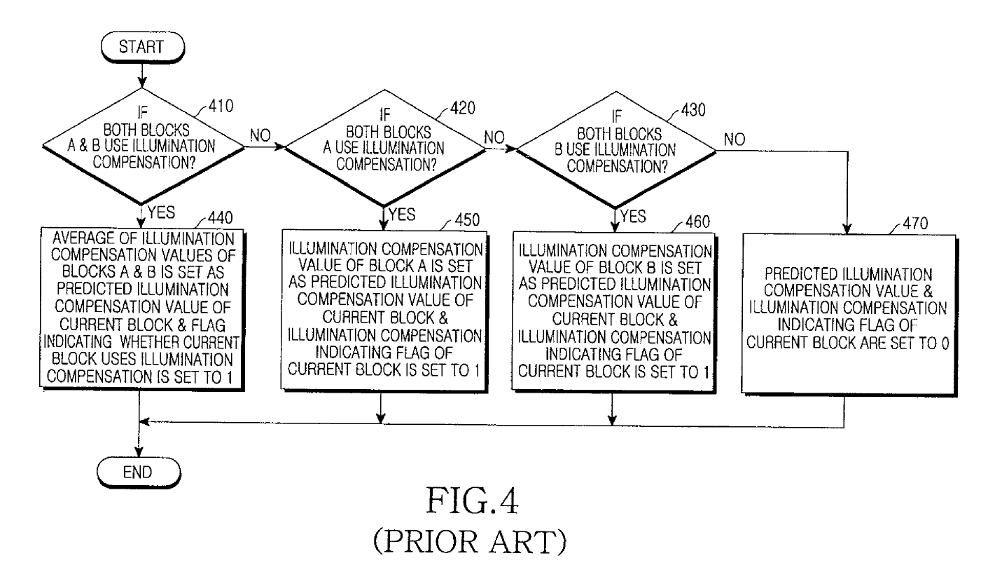

In the case of a P skip mode block, which corresponds to the second block type, a predicted illumination compensation value derived from the blocks A and B located around the current block is used as the illumination compensation value. A method for deriving a predicted illumination compensation value in the P skip mode will be described hereinafter with reference to FIG. 4.

FIG. 4 is a flow diagram of a process of deriving a predicted illumination compensation value and an illumination compensation indicating flag from P skip mode blocks. Referring to FIG. 4, in step 410, a determination is made whether both of the block A, which is an upper neighbor block of the current block, and the block B, which is a left neighbor block of the current block, use the illumination compensation. As a result of the determination in step 410, when both of the block A and the block B use the illumination compensation, an average value of the illumination compensation values of the blocks A and B is set as a predicted illumination compensation value of the current block, and a flag indicating whether the current block uses the illumination compensation is set to “1” (step 440). Then, the process is terminated.

As a result of the determination in step 410, when any of the block A and the block B does not use the illumination compensation, a determination is made whether only the block A uses the illumination compensation while the block B does not use the illumination compensation (step 420). As a result of the determination in step 420, when only the block A uses the illumination compensation, the illumination compensation value of the block A is set as a predicted illumination compensation value of the current block, and the flag indicating if the current block uses the illumination compensation is set to “1” (step 450). Then, the process is terminated.

As a result of the determination in step 420, when the block A does not use the illumination compensation, it is determined if only the block B uses the illumination compensation while the block A does not use the illumination compensation (step 430). As a result of the determination in step 430, when only the block B uses the illumination compensation, the illumination compensation value of the block B is set as a predicted illumination compensation value of the current block, and the flag indicating whether the current block uses the illumination compensation is set to “1” (step 460). Then, the process is terminated.

As a result of the determination in step 430, when the block B also does not use the illumination compensation, the predicted illumination compensation value of the current block is set to “0” and the flag indicating if the current block uses the illumination compensation is set to “0” (step 470). Then, the process is terminated.

In the case of a B skip mode block, flag information on whether a current blocks uses illumination compensation is derived from the neighbor blocks A, B, and C of the current block.

When the derived illumination compensation indicating flag is “1,” the method of deriving a predicted illumination compensation value (as shown in FIG. 3), which is used in the block type corresponding to the case of transmitting an illumination compensation indicating flag and an illumination compensation value difference (inter 16×16 mode, B direct 16×16 mode), is used as it is. Further, when the derived illumination compensation indicating flag is “0,” the illumination compensation value is set to “0.”

Basically, blocks A, B, and C are used in deriving the illumination compensation indicating flag. When the block C is not available, the block D is used instead of the block C. A method of deriving an illumination compensation indicating flag of a B skip mode block will be described below.

First, when a reference picture of one block among the blocks A, B, and C around the current block is equal to a reference picture of the current block, an illumination compensation indicating flag of the block having the same reference picture as that of the current block is used as an illumination compensation indicating flag of the current block. However, when a reference picture of one block among the blocks A, B, and C around the current block is not equal to the reference picture of the current block, a median value of illumination compensation indicating flags of the blocks A, B, and C is used as the illumination compensation indicating flag of the current block.

In a method corresponding to the P skip mode from among the methods of deriving a predicted illumination compensation value included in current international multi-view video coding standards, the predicted illumination compensation value is derived from the blocks A and B. When both of the two blocks use the illumination compensation, an average of the illumination compensation values of the blocks A and B is used as an illumination compensation value of the current block. However, when the average of the illumination compensation values of the blocks A and B is 0, an illumination compensation indicating flag of the current block is 1 and the predicted illumination compensation value of the current block is 0.

The existing method of deriving an illumination compensation indicating flag and a predicted illumination compensation value as described above may yield a case where the predicted illumination compensation value is 0 when the illumination compensation indicating flag is 1. This case may have a continuous effect on the prediction, which may degrade the entire coding capability.

The present invention proposes a method for prediction in a simple and constant manner in deriving a predicted illumination compensation value and an illumination compensation indicating flag in a skip mode of an illumination compensation process of a multi-view video coding, and a method for efficiently transmitting information of an illumination compensation indicating flag and a predicted illumination compensation value in a block mode of transmitting the illumination compensation indicating flag and an illumination compensation value difference.

### Method for Illumination Compensation of a P Skip Mode—1

In a method of predicting an illumination compensation indicating flag and an illumination compensation value in a P skip mode according to an embodiment of the present invention, when both the block A and the block B of FIG. 2 use illumination compensation, the predicted illumination compensation value is first derived, and the illumination compensation indicating flag is then determined based on the derived predicted illumination compensation value. Specifically, the illumination compensation indicating flag is determined to be 0 when the derived predicted illumination compensation value is 0, and the illumination compensation indicating flag is determined to be 1 when the derived predicted illumination compensation value is not 0. When both of the blocks A and B do not use the illumination compensation, the predicted illumination compensation value is derived according to the existing method.

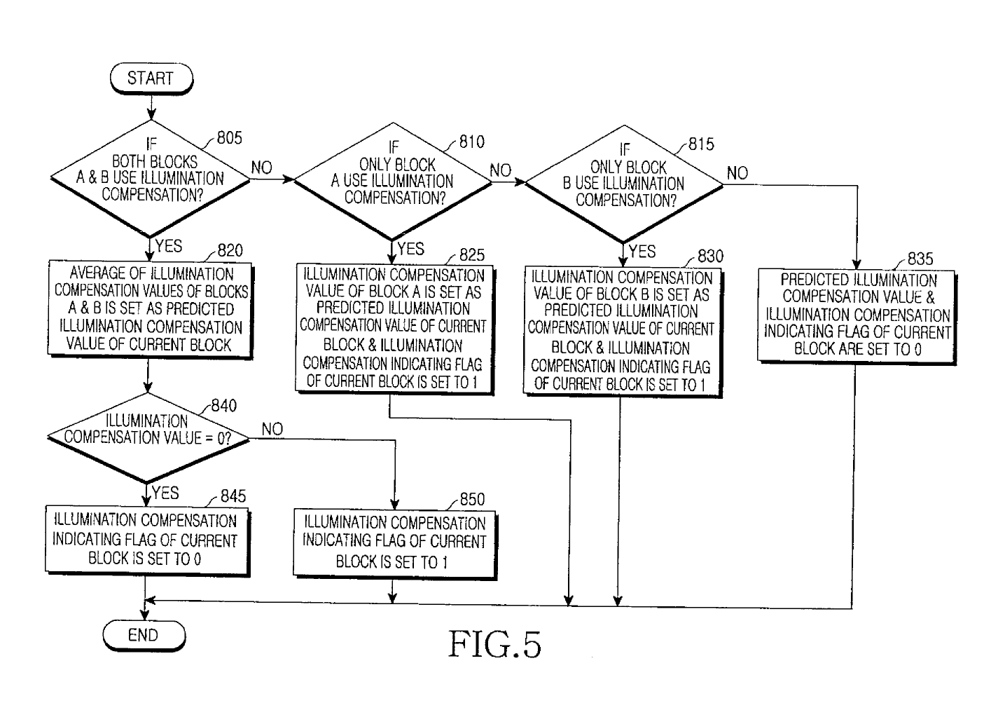

FIG. 5 is a flow diagram of a process of deriving a predicted illumination compensation value and an illumination compensation indicating flag from P skip mode blocks.

A process of deriving a predicted illumination compensation value and an illumination compensation indicating flag from P skip mode blocks according to an embodiment of the present invention is described with reference to FIG. 5. Referring to FIG. 5, in step 805 it is determined whether both block A and block B use the illumination compensation. As a result of the determination in step 805, when both of the block A and the block B use the illumination compensation, an average value of the illumination compensation values of blocks A and B is used as a predicted illumination compensation value of the current block (step 820). Otherwise, it is determined if the illumination compensation value is “0” (step 840). As a result of the determination in step 840, when the illumination compensation value is “0,” a flag indicating whether the current block uses the illumination compensation is set to “o” (step 845), and then the process is terminated. In contrast, when the determination in step 840 shows that the illumination compensation value is not “0,” the flag indicating whether the current block uses the illumination compensation is set to “1” (step 850), and then the process is terminated.

As a result of the determination in step 805, when either of the block A and the block B does not use the illumination compensation, the next step of the existing method of deriving a predicted illumination compensation value is performed (step 810). That is, in step 810, it is determined if only the block A uses the illumination compensation while the block B does not use the illumination compensation. As a result of the determination in step 810, when only block A uses the illumination compensation, the illumination compensation value of block A is used as a predicted illumination compensation value of the current block, and the flag indicating whether the current block uses the illumination compensation is set to “1” (step 825). Then, the process is terminated.

Otherwise, when the block A does not use the illumination compensation, it is determined if only block B uses the illumination compensation while block A does not use the illumination compensation (step 815). As a result of the determination in step 815, when only block B uses the illumination compensation, the illumination compensation value of block B is used as the predicted illumination compensation value of the current block, and the flag indicating whether the current block uses illumination compensation is set to “1” (step 830). Then, the process is terminated.

As a result of the determination in step 815, when block B also does not use the illumination compensation, the predicted illumination compensation value of the current block is set to “0” and the flag indicating whether the current block uses the illumination compensation is set to “0” (step 835). Then, the process is terminated.

### Method for Illumination Compensation of a P Skip Mode—2

In a method of predicting an illumination compensation indicating flag and an illumination compensation value in a P skip mode according to another embodiment of the present invention, an existing process of deriving a predicted illumination compensation value in a P skip mode is first performed, and the illumination compensation indicating flag is then determined based on the derived predicted illumination compensation value. Specifically, the illumination compensation indicating flag is determined to be 0 when the derived predicted illumination compensation value is 0, and the illumination compensation indicating flag is determined to be 1 when the derived predicted illumination compensation value is not 0.

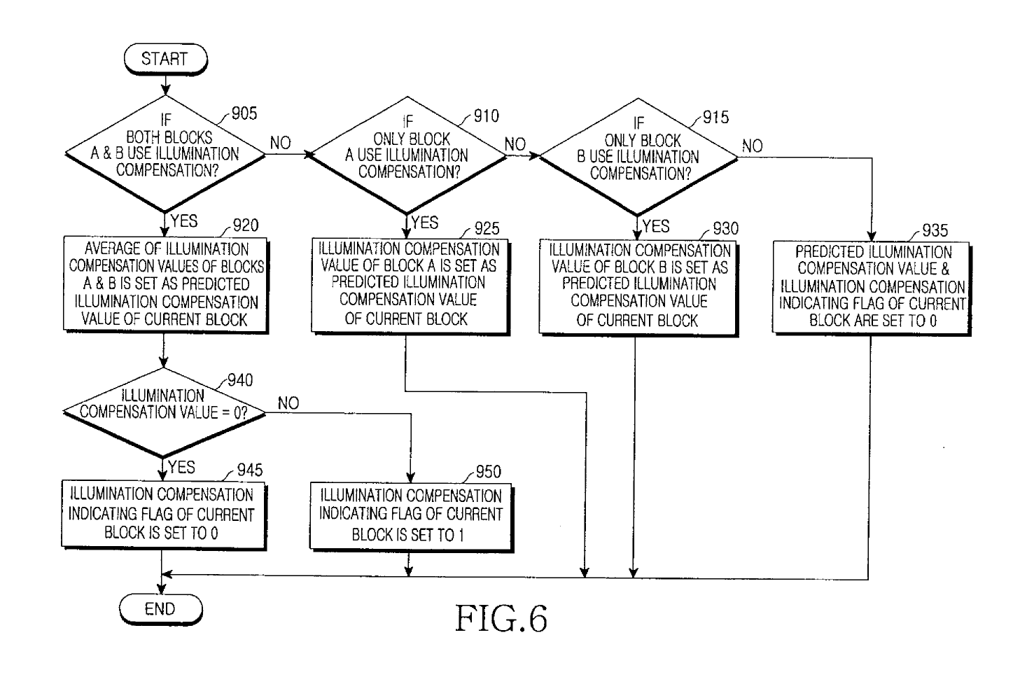

FIG. 6 is a flow diagram of a process of deriving a predicted illumination compensation value and an illumination compensation indicating flag from P skip mode blocks according to another embodiment of the present invention.

Referring to FIG. 6, in step 905, a determination is made whether both of block A and block B use illumination compensation. As a result of the determination in step 905, when both of block A and block B use the illumination compensation, an average value of the illumination compensation values of blocks A and B is used as a predicted illumination compensation value of the current block (step 920) and step 940 is then performed.

Otherwise, when only one of block A and block B uses illumination compensation, it is determined if only block A uses the illumination compensation while the block B does not use the illumination compensation (step 910). As a result of the determination in step 910, when only block A uses the illumination compensation, the illumination compensation value of the block A is used as a predicted illumination compensation value of the current block (step 925). Then, step 940 is performed.

As a result of the determination in step 910, when the block A does not use the illumination compensation, it is determined if only the block B uses the illumination compensation while the block A does not use the illumination compensation (step 915). As a result of the determination in step 915, when only block B uses the illumination compensation, the illumination compensation value of block B is used as the predicted illumination compensation value of the current block (step 930). Then, step 940 is performed.

As a result of the determination in step 915, when block B also does not use the illumination compensation, the predicted illumination compensation value of the current block is set to “0” and the flag indicating whether the current block uses the illumination compensation is set to “0” (step 935). Then, the process is terminated.

Meanwhile, after the predicted illumination compensation value of the current block is set in one of steps 920, 925, and 930, it is determined if the illumination compensation value is “0” (step 940).

As a result of the determination in step 940, when the illumination compensation value is “0,” the flag indicating whether the current block uses the illumination compensation is set to “0” (step 945), and the process is then terminated. In contrast, when the determination in step 940 shows that the illumination compensation value is not “0,” the flag indicating whether the current block uses the illumination compensation is set to “1” (step 950), and the process is then terminated.

### Method of Illumination Compensation in the Case of Transmitting an Illumination Compensation Indicating Flag and an Illumination Compensation Value Difference (Inter 16×16 Mode, B-Direct Mode)—1

As a result of an operation of coding an illumination compensation indicating flag and illumination compensation information in the case of transmitting an illumination compensation indicating flag and an illumination compensation value difference in an inter 16×16 mode and B-direct mode according to the present invention, when a current illumination compensation value obtained by an encoder is “0,” the illumination compensation indicating flag may be encoded to “0” while the illumination compensation information is not encoded. Further, when the current illumination compensation value obtained by an encoder is not “0,” the illumination compensation indicating flag can be encoded to “1.”

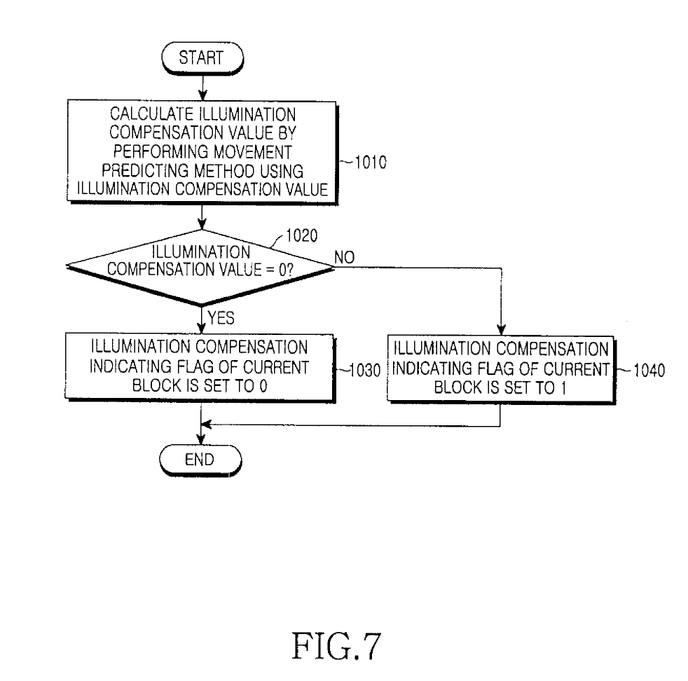

FIG. 7 is a flow diagram of a process of predicting an illumination compensation indicating flag in the case of transmitting an illumination compensation indicating flag and an illumination compensation value difference according to an embodiment of the present invention.

Referring to FIG. 7, first in step 1010, an illumination compensation value is calculated by performing a movement predicting method using an illumination compensation value. Then, in step 1020, it is determined if the calculated illumination compensation value is “0.” As a result of the determination in step 1020, when the calculated illumination compensation value is “0,” the illumination compensation indicating flag is encoded to “0” (step 1030). In comparison, the determination in step 1020 shows that the calculated illumination compensation value is not “0,” the illumination compensation indicating flag is encoded to “1” (step 1040).

Method of Illumination Compensation in the Case of Transmitting an Illumination Compensation Indicating Flag and an Illumination Compensation Value Difference (Inter 16×16 Mode B-Direct Mode)—2

As a result of an operation of coding an illumination compensation indicating flag and illumination compensation information in the case of transmitting an illumination compensation indicating flag and an illumination compensation value difference in an inter 16×16 mode and B-direct mode according to the present invention, when a current illumination compensation value obtained by an encoder is “0” and a predicted illumination compensation value derived in order to obtain an illumination compensation value difference is also “0,” the illumination compensation indicating flag may be encoded to “0” while the illumination compensation information is not encoded. Further, when the current illumination compensation value obtained by an encoder is not “0” or the derived predicted illumination compensation value is not “0,” the illumination compensation indicating flag can be encoded to “1.”

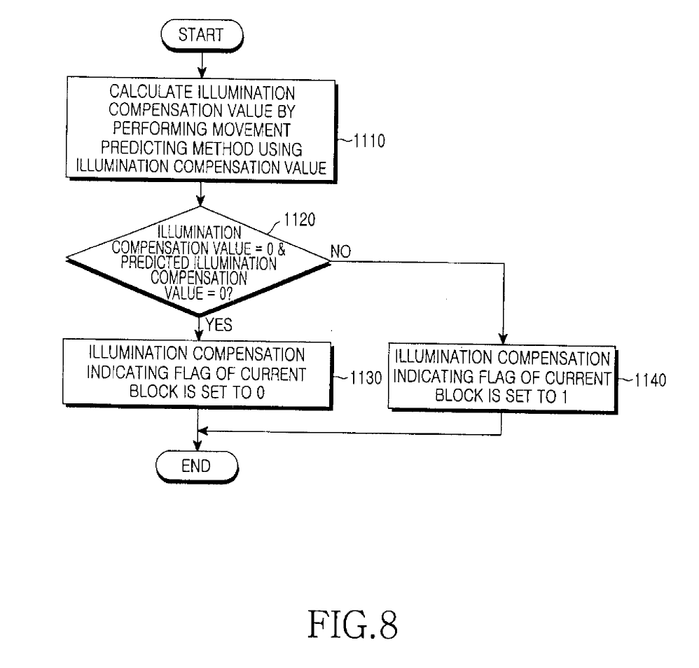

FIG. 8 is a flow diagram of a process of predicting an illumination compensation indicating flag in the case of transmitting an illumination compensation indicating flag and an illumination compensation value difference according to another embodiment of the present invention.

Referring to FIG. 8, in step 110, an illumination compensation value is calculated by performing a movement predicting method using an illumination compensation value. In step 1120, it is determined if the calculated illumination compensation value is “0,” and if the derived predicted illumination compensation value is “0.” As a result of the determination in step 1120, when the calculated illumination compensation value is “0” and the derived predicted illumination compensation value is “0,” the illumination compensation indicating flag of the current block is encoded to “0” (step 1130). In comparison, the determination in step 1120 shows that the calculated illumination compensation value is not “0” or the derived predicted illumination compensation value is not “0,” the illumination compensation indicating flag of the current block is encoded to “1” (step 1140).

### Illumination Compensation Apparatus of P Skip Block

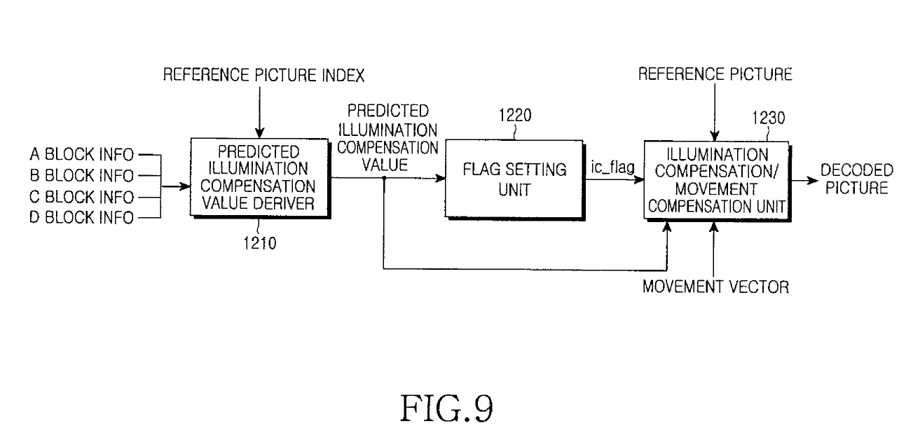

FIG. 9 is a block diagram of an apparatus for deriving a predicted illumination compensation value and an illumination compensation indicating flag from skip mode blocks according to an embodiment of the present invention.

Referring to FIG. 9, an apparatus for deriving a predicted illumination compensation value and an illumination compensation indicating flag from skip mode blocks according to an embodiment of the present invention includes a predicted illumination compensation value deriver 1210, a flag setting unit 1220, and an illumination compensation/movement compensation unit 1230.

The predicted illumination compensation value deriver 1210 receives information (an illumination compensation indicating flag, an illumination compensation value, a reference picture index, a block type, etc.) of neighbor blocks (blocks A, B, C, and D of FIG. 2) of the current block, and derives and outputs a predicted illumination compensation value, by using an existing method of deriving a predicted illumination compensation value.

The multi-view video coding, international standardization of which is in progress, uses blocks A and B in the P skip mode. Specifically, the P skip mode uses the existing method of predicting an illumination compensation value.

The flag setting unit 1220 receives the predicted illumination compensation value derived by the predicted illumination compensation value deriver 1210, and sets and outputs an illumination compensation indicating flag according to a method proposed by the present invention.

In a method according to an embodiment of the present invention in the case of the P skip mode, when both of blocks A and B use illumination compensation in an existing illumination compensation value predicting method, an average value of the illumination compensation values of blocks A and B is used as a predicted illumination compensation value, and this predicted illumination compensation value is used as an illumination compensation value of the current block. The illumination compensation indicating flag is set to “0” when the derived predicted illumination compensation value is “0,” and is set to “1” when the derived predicted illumination compensation value is not “0.”

In a method according to another embodiment of the present invention in the case of the P skip mode, an existing method of deriving a predicted illumination compensation value is first performed. Then, the illumination compensation indicating flag is set to “0” when the derived predicted illumination compensation value is “0,” and is set to “1” when the derived predicted illumination compensation value is not “0.”

The illumination compensation/movement compensation unit 1230 outputs a decoded picture by performing illumination compensation and movement compensation by using an illumination compensation indicating flag, a predicted illumination compensation value, a reference picture, and a movement vector.

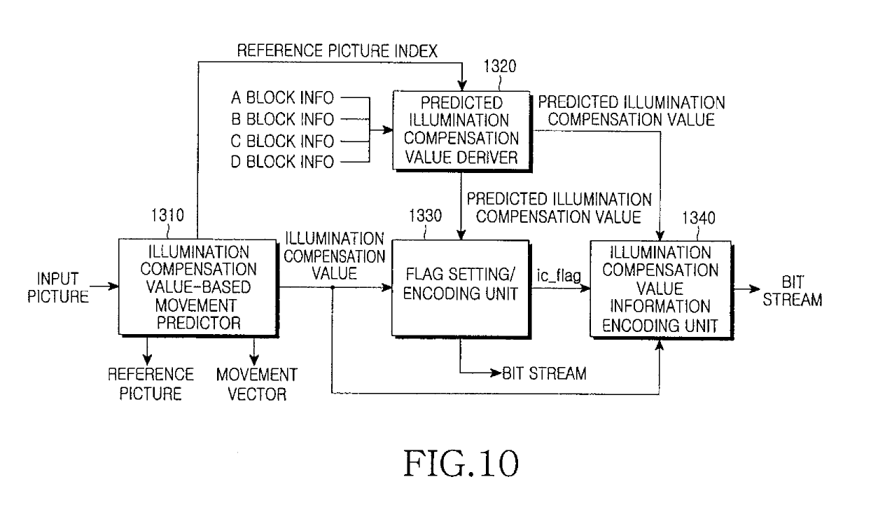

FIG. 10 is a flow diagram of an encoder for encoding an illumination compensation indicating flag and an illumination compensation value in a block mode in the case of transmitting an illumination compensation indicating flag and an illumination compensation value difference according to an embodiment of the present invention. The encoder includes an illumination compensation value-based movement predictor 1310, a predicted illumination compensation value deriver 1320, a flag setting/encoding unit 1330, and an illumination compensation value information encoding unit 1340.

The illumination compensation value-based movement predictor 1310 extracts a movement vector by using input pictures, and outputs an illumination compensation value and a reference picture index.

The predicted illumination compensation value deriver 1320 derives and outputs a predicted illumination compensation value by using a reference picture index input from the illumination compensation value-based movement predictor 1310 and information (an illumination compensation indicating flag, an illumination compensation value, a reference picture index, a block type, etc.) of neighbor blocks (blocks A, B, C, and D of FIG. 2) of the current block.

The flag setting/encoding unit 1330 receives the illumination compensation value and the predicted illumination compensation value, and sets and encodes an illumination compensation indicating flag according to an illumination compensation indicating flag deriving method proposed by the present invention, thereby outputting a bit stream of corresponding information.

In the encoding by the encoder for encoding an illumination compensation indicating flag and an illumination compensation value in a block mode in the case of transmitting an illumination compensation indicating flag and an illumination compensation value difference according to an embodiment of the present invention, the illumination compensation indicating flag is set to “0” when the derived illumination compensation value is “0,” and is set to “1” when the derived illumination compensation value is not “0.”

In the encoding by the encoder for encoding an illumination compensation indicating flag and an illumination compensation value in a block mode in the case of transmitting an illumination compensation indicating flag and an illumination compensation value difference according to another embodiment of the present invention, the illumination compensation indicating flag is set to “0” when the derived illumination compensation value is “0” and the derived predicted illumination compensation value is “0.” Otherwise, the illumination compensation indicating flag is set to “1” in the encoding by the encoder.

The illumination compensation value information encoding unit 1340 operates based on the illumination compensation indicating flag input from the flag setting/encoding unit 1330. Specifically, when the flag is “0,” the illumination compensation value information encoding unit 1340 does not encode information of the illumination compensation value. In contrast, when the flag is “1,” the illumination compensation value information encoding unit 1340 obtains an illumination compensation value difference by subtracting the predicted illumination compensation value obtained by the predicted illumination compensation value deriver 1320 from the illumination compensation value (illumination compensation value minus predicted illumination compensation value), and encodes the obtained illumination compensation value difference, thereby outputting a bit stream of corresponding information.

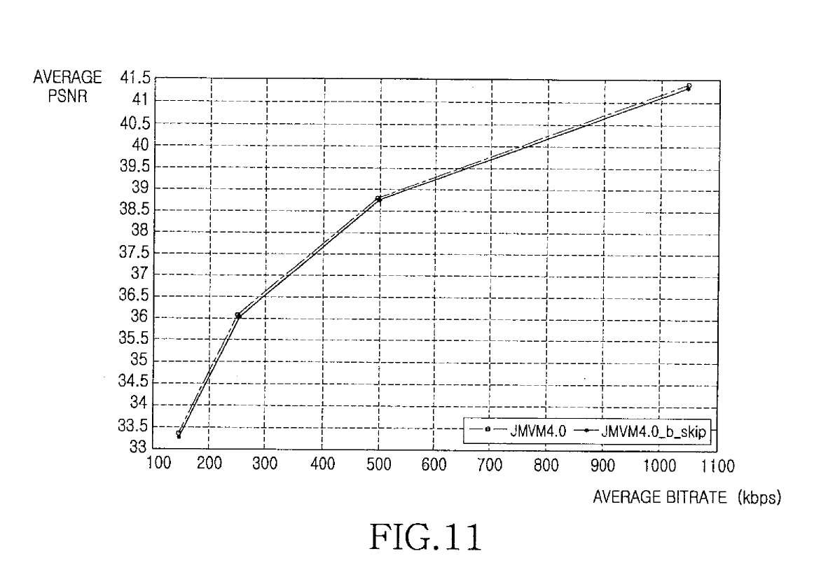

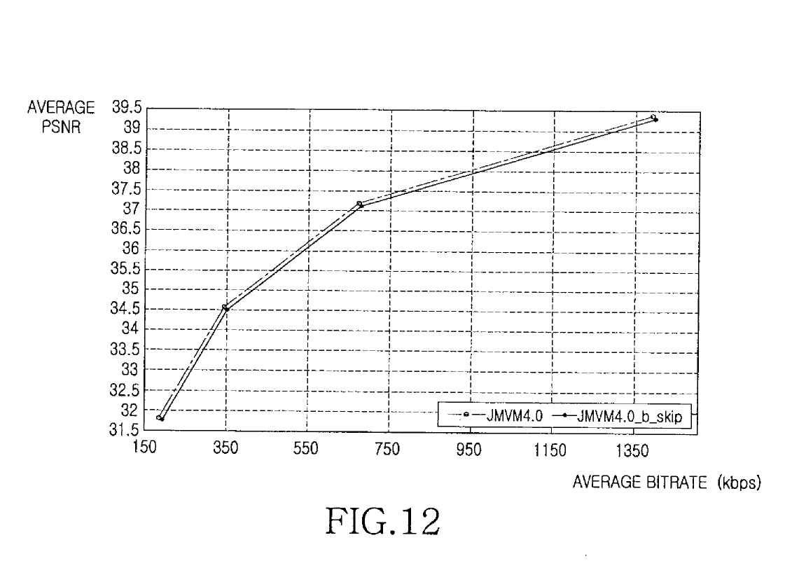

FIGS. 11 and 12 are graphs showing a comparison between an existing illumination compensation method and an illumination compensation method according to an embodiment of the present invention for a Racel VGA 30 Hz picture sequence and a Ballroom VGA 25 Hz picture sequence, respectively.

The existing method and the inventive method were tested by using JMVM 4.0 with changing Quantization Parameters (QPs) of 22, 27, 32, and 37 for a Racel VGA 30 Hz picture sequence and a Ballroom VGA 25 Hz picture sequence, respectively. Results of the test are shown in FIGS. 11 and 12, which denotes that the existing method and the proposed method actually have similar performances.

In a method for illumination compensation in a multi-view video coding according to the present invention, an illumination compensation indicating flag is set based on a derived predicted illumination compensation value. Therefore, it is possible to omit an operation of deriving an illumination compensation indicating flag, which can reduce the quantity of operation. Further, the present invention can prevent the illumination compensation indicating flag in each block type from being derived to “1” simultaneously while the predicted illumination compensation is derived to “0.” Further, in the case of the block type transmitting an illumination compensation indicating flag and an illumination compensation value difference, the illumination compensation indicating flag can be set to “0” or “11,” even when the illumination compensation value obtained by the encoder is “0.” Therefore, according to the present invention, it is possible to more efficiently derive an illumination compensation indicating flag and a predicted illumination compensation value, which can improve the coding efficiency.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to certain exemplary embodiments thereof, it will be understood by those skilled in the art that various changes in form and details may be made therein without departing from the spirit and scope of the invention as defined by the appended claims. For example, although reference is made to the values of 0 and 1, it would be recognized that these values are only referred to by way of example and that these values may be interchanged or replaced by other value, e.g., 1 and 0, respectively or a first value and a second value.

What is claimed is:

1. A method of illumination compensation in a multi view video coding, the method comprising:
deriving a predicted illumination compensation value of the current block by using information on neighbor blocks of the current block, when in a skip mode;
setting the current block not to perform the illumination compensation when the derived predicted illumination compensation value is 0; and
setting the current block to perform the illumination compensation when the derived predicted illumination compensation value is not 0.

2. The method of claim 1, wherein the information on the neighbor blocks of the current block comprises an illumination compensation value, a reference picture index, a block type, and a flag value indicating whether a corresponding one of the neighbor blocks performs illumination compensation.

3. The method of claim 1, wherein, when the current block is in a P skip mode, the neighbor blocks of the current block comprise a first block, which is an upper neighbor block of the current block, and a second block, which is a left neighbor block of the current block.

4. The method of claim 3, wherein, when the current block is in a P skip mode, the step of deriving a predicted illumination compensation value of the current block comprises:
when both the first block and the second block perform illumination compensation, determining an average of the illumination compensation values of the first block and the second block and using this determined average value as a predicted illumination compensation value of the current block;
when the first block performs illumination compensation while the second block does not perform illumination compensation, using the illumination compensation value of the first block as the predicted illumination compensation value of the current block;
when the second block performs illumination compensation while the first block does not perform illumination compensation, using the illumination compensation value of the second block as the predicted illumination compensation value of the current block; and
when both of the first block and the second block do not perform illumination compensation, setting the predicted illumination compensation value of the current block to 0.

5. The method of claim 1, wherein setting the current block not to perform the illumination compensation corresponds to setting a flag value indicating if the current block performs illumination compensation to 0, and setting the current block to perform the illumination compensation corresponds to setting the flag value indicating if the current block performs illumination compensation to 1.

6. A method of illumination compensation in a multi view video coding, the method comprising:
when a current block is in a block mode transmitting an illumination compensation value difference and a flag indicating if the current block performs illumination compensation, calculating an illumination compensation value;
setting the current block not to perform the illumination compensation when the illumination compensation value is 0; and
setting the current block to perform the illumination compensation when the illumination compensation value is not 0.

7. The method of claim 6, wherein the step of setting the current block not to perform the illumination compensation corresponds to setting a flag value indicating if the current block performs illumination compensation to 0, and the step of setting the current block to perform the illumination compensation corresponds to setting the flag value indicating if the current block performs illumination compensation to 1.

8. A method of illumination compensation in a multi view video coding, the method comprising:
when a current block is in a block mode transmitting an illumination compensation value difference and a flag indicating if the current block uses illumination compensation, calculating an illumination compensation value and deriving a predicted illumination compensation value by using neighbor blocks of the current block;
setting the current block not to perform the illumination compensation when the illumination compensation value and the predicted illumination compensation value are 0; and
setting the current block to perform the illumination compensation when any of the illumination compensation value and the predicted illumination compensation value of a first and second block is not 0.

9. The method of claim 8, wherein the information on the neighbor blocks of the current block comprises an illumination compensation value, a reference picture index, a block type, and a flag value indicating if corresponding neighbor blocks perform illumination compensation.

10. The method of claim 8, wherein, when the current block is in a block mode transmitting an illumination compensation value difference and a flag indicating if the current block performs illumination compensation, the neighbor blocks of the current block comprise a first block, which is an upper neighbor block of the current block, a second block, which is a left neighbor block of the current block, a third block, which is a right neighbor block of the first block, and a fourth block, which is an upper neighbor block of the second block.

11. The method of claim 8, wherein the deriving a predicted illumination compensation value of the current block comprises:
determining if the first block, which is the upper neighbor block of the current block, uses illumination compensation, and setting an illumination compensation value of the first block as the predicted illumination compensation value of the current block when the picture referred to by the first block is equal to the picture referred to by the current block;
when the picture referred to by the first block is not equal to the picture referred to by the current block, determining if the second block, which is the left neighbor block of the current block, uses illumination compensation, and setting an illumination compensation value of the second block as the predicted illumination compensation value of the current block when the picture referred to by the second block is equal to the picture referred to by the current block;
when the picture referred to by the second block is not equal to the picture referred to by the current block, determining if the third block, which is the right neighbor block of the first block, uses illumination compensation, and setting an illumination compensation value of the third block as the predicted illumination compensation value of the current block when the picture referred to by the third block is equal to the picture referred to by the current block;
when the picture referred to by the third block is not equal to the picture referred to by the current block, determining if the fourth block, which is the upper neighbor block of the second block, uses illumination compensation, and setting an illumination compensation value of the fourth block as the predicted illumination compensation value of the current block when the picture referred to by the fourth block is equal to the picture referred to by the current block;
when the picture referred to by the fourth block is not equal to the picture referred to by the current block, determining if each of the first block, the second block, and the third block use illumination compensation, and setting a median value of illumination compensation values of the first block, the second block, and the third block as the predicted illumination compensation value of the current block when all of the first block, the second block, and the third block use illumination compensation; and
when none of the first block, the second block, and the third block do not perform illumination compensation, setting the predicted illumination compensation value of the current block to 0.

12. The method of claim 8, wherein the step of setting the current block not to perform the illumination compensation corresponds to setting a flag value indicating if the current block performs illumination compensation to 0, and the step of setting the current block to perform the illumination compensation corresponds to setting the flag value indicating if the current block performs illumination compensation to 1.

13. An apparatus for illumination compensation when a current block performing illumination compensation is in a skip mode in a multi view video coding, comprising:
a predicted illumination compensation value deriver for receiving a reference picture index of the current block and information on neighbor blocks of the current block, and deriving and outputting a predicted illumination compensation value;
a flag setting unit for receiving the derived predicted illumination compensation value, and setting and outputting a flag indicating if the current block performs illumination compensation, based on the derived predicted illumination compensation value; and
an illumination compensation/movement compensation unit for performing illumination compensation and movement compensation by using a movement vector, a reference picture, the predicted illumination compensation value, and the flag indicating if the current block performs illumination compensation.

14. The apparatus of claim 13, wherein the information on the neighbor blocks of the current block comprises an illumination compensation value, a reference picture index, a block type, and a flag value indicating if corresponding neighbor blocks perform illumination compensation.

15. The apparatus of claim 13, wherein, when the current block is in a P skip mode, the neighbor blocks of the current block comprise a first block, which is an upper neighbor block of the current block, and a second block, which is a left neighbor block of the current block.

16. The apparatus of claim 13, wherein, when the current block is in a P skip mode, the predicted illumination compensation value deriver performs:
when both the first block, which is the upper neighbor block of the current block, and the second block, which is the left neighbor block of the current block, perform illumination compensation, setting an average of illumination compensation values of the first block and the second block as a predicted illumination compensation value of the current block;
when the first block performs illumination compensation while the second block does not perform illumination compensation, setting an illumination compensation value of the first block as the predicted illumination compensation value of the current block;
when the second block performs illumination compensation while the first block does not perform illumination compensation, setting an illumination compensation value of the second block as the predicted illumination compensation value of the current block; and
when both of the first block and the second block do not perform illumination compensation, setting the predicted illumination compensation value of the current block to 0.

17. The apparatus of claim 13, wherein the flag setting unit sets a flag value indicating if the current block performs illumination compensation to 0 when the received derived predicted illumination compensation value is 0, and sets the flag value to 1 when the received derived predicted illumination compensation value is not 0.

18. An apparatus of illumination compensation when a current block is in a block mode transmitting an illumination compensation value difference and an illumination compensation indicating flag indicating if the current block uses illumination compensation in a multi view video coding, comprising:
an illumination compensation value-based movement predictor for extracting a movement vector by using input pictures and reference pictures, and outputting an illumination compensation value and a reference picture index;
a predicted illumination compensation value deriver for deriving and outputting a predicted illumination compensation value by using a reference picture index input from the illumination compensation value-based movement predictor and information of neighbor blocks of the current block;
a flag setting/encoding unit for receiving the illumination compensation value from the illumination compensation value-based movement predictor and the predicted illumination compensation value from the predicted illumination compensation value deriver, and setting, encoding, and outputting the illumination compensation indicating flag; and
an illumination compensation value information encoding unit, which does not encode information of the illumination compensation value when the flag is 0, and encodes and outputs an illumination compensation value difference, which is obtained by subtracting the predicted illumination compensation value input from the predicted illumination compensation value deriver from the illumination compensation value, when the flag is 1.

19. The apparatus of claim 18, wherein the information on the neighbor blocks of the current block comprises an illumination compensation value, a reference picture index, a block type, and a flag value indicating if corresponding neighbor blocks perform illumination compensation.

20. The apparatus of claim 18, wherein the neighbor blocks of the current block comprise a first block, which is an upper neighbor block of the current block, a second block, which is a left neighbor block of the current block, a third block, which is a right neighbor block of the first block, and a fourth block, which is an upper neighbor block of the second block.

21. The apparatus of claim 18, wherein the predicted illumination compensation value deriver performs:
determining if the first block, which is the upper neighbor block of the current block, uses illumination compensation and if a picture referred to by the first block is equal to a picture referred to by the current block, and setting an illumination compensation value of the first block as the predicted illumination compensation value of the current block when the picture referred to by the first block is equal to the picture referred to by the current block;
when the picture referred to by the first block is not equal to the picture referred to by the current block, determining if the second block, which is the left neighbor block of the current block, uses illumination compensation and if a picture referred to by the second block is equal to the picture referred to by the current block, and setting an illumination compensation value of the second block as the predicted illumination compensation value of the current block when the picture referred to by the second block is equal to the picture referred to by the current block;
when the picture referred to by the second block is not equal to the picture referred to by the current block, determining if the third block, which is the right neighbor block of the first block, uses illumination compensation and if a picture referred to by the third block is equal to the picture referred to by the current block, and setting an illumination compensation value of the third block as the predicted illumination compensation value of the current block when the picture referred to by the third block is equal to the picture referred to by the current block;
when the picture referred to by the third block is not equal to the picture referred to by the current block, determining if the fourth block, which is the upper neighbor block of the second block, uses illumination compensation and if a picture referred to by the fourth block is equal to the picture referred to by the current block, and setting an illumination compensation value of the fourth block as the predicted illumination compensation value of the current block when the picture referred to by the fourth block is equal to the picture referred to by the current block; and
when the picture referred to by the fourth block is not equal to the picture referred to by the current block, determining if all of the first block, the second block, and the third block use illumination compensation, and setting a median value of illumination compensation values of the first block, the second block, and the third block as the predicted illumination compensation value of the current block when all of the first block, the second block, and the third block use illumination compensation; and
when any of the first block, the second block, and the third block does not perform illumination compensation, setting the predicted illumination compensation value of the current block to 0.

22. The apparatus of claim 18, wherein the flag setting/encoding unit sets the illumination compensation indicating flag to 0 when the received derived predicted illumination compensation value is 0, and sets the illumination compensation indicating flag to 1 when the received derived predicted illumination compensation value is not 0.

23. The apparatus of claim 18, wherein the flag setting/encoding unit sets the illumination compensation indicating flag to 0 when the illumination compensation value and the predicted illumination compensation value are 0, and sets the illumination compensation indicating flag to 1 when any of the illumination compensation value and the predicted illumination compensation value is not 0.
